(19) United States
(12) Patent Application Publication
(10) Pub. No.: US 2018/0363882 A1
(43) Pub. Date: Dec. 20, 2018

(54) FLUORESCENCE ENHANCING GEL-FILM AND THE MANUFACTURE METHOD THEREOF

(71) Applicant: FENG CHIA UNIVERSITY, Taichung City (TW)

(72) Inventor: CHUN-FENG LAI, Taichung City (TW)

(21) Appl. No.: 16/005,654

(22) Filed: Jun. 11, 2018

(30) Foreign Application Priority Data
Jun. 14, 2017 (CN) 201710449207.0

(51) Int. Cl. F21V 9/30; B29C 67/20; C08J 5/18

(52) U.S. Cl. CPC F21V 9/30; B29K 2105/0061; C08J 5/18; B29C 67/202

(57) ABSTRACT

The present invention discloses a fluorescence enhancing gel-film and the manufacture method thereof. The aforementioned fluorescence enhancing gel-film comprises a frame-gel and a nano-scale spherical cavity structure. The frame-gel is in a form of a film. The nano-scale spherical cavity structure which is distributed in a periodic or non-periodic arrangement is disposed in the frame-gel. The fluorescence enhancing gel-film is able to improve the emitting performance and efficiency of a light emitting device significantly.

### CROSS-REFERENCE TO RELATED APPLICATION AND CLAIM OF PRIORITY

This application claims the benefit of Chinese Patent Application No. 201710449207.0, filed on Jun. 14, 2017, in the State Intellectual Property Office of the People's Republic of China, the disclosure of which is incorporated herein its entirety by reference.

### 1. TECHNICAL FIELD

This invention discloses a fluorescence enhancing gel-film and the manufacture method thereof. More particularly, the invention relates to a fluorescence enhancing gel-film and the manufacture method which include a periodic or non-periodic nano-scale spherical cavity structure.

### 2. DESCRIPTION OF THE RELATED ART

Colored panels or light-emitting devices such as LEDs have become increasingly popular and important applications in people's daily lives such as televisions, computers, tablet computers, smart phones and so on.

The color displayed by the color panel in the prior art mainly depends on the color component of the light emitted from the backlight of the display. The existing mainstream color panel usually uses a cold cathode fluorescent lamp (CCFL) or a white light emitting diode (WLED) as backlight.

For example, if the backlight is a white light emitting diode (WLED), it utilizes a blue LED to excite the inorganic green and red phosphors when passing through the color filter. However, the FWHM of the white light emitting diode in luminescence spectrum is wider, it causes the color purity of the three primary colors of red, green, and blue is individually low, and it results in the display of colors that are confined to a narrower gamut of NTSC (National Television System Committee). Therefore, the color of the picture displayed by such a color panel is darker than that of the original object.

Based on the above reasons, lots of people began to study how to make a color panel which includes better brightness or color performance. The main technology nowadays is adding one or more layers of quantum dot optical film (QD film) into the structure of light emitting device or the panel to change the characteristics and performance of the light emission spectrum. However, the existing technology still lacks an effective way to achieve comprehensive improvement in light intensity, narrow emission spectrum, or color gamut.

### SUMMARY

To solve the aforesaid problems of the prior art, the present invention provides a fluorescence enhancing gel-film and the manufacture method thereof. The fluorescence enhancing gel-film comprises a frame-gel and a nano-scale spherical cavity structure. The frame-gel is in the form of a film. The nano-scale spherical cavity structure is disposed in the frame-gel, and the nano-scale spherical cavity structure is distributed in a periodic or non-periodic arrangement.

In addition, the present invention provides further provides a method of manufacturing a fluorescence enhancing gel-film comprising the steps (a) to (e). The method begins with step (a), which is stacking a plurality of nanospheres into a periodic or non-periodic stacking structure. In the following step (b), a frame-gel is infiltrated into an interspace of the stacking structure. In the following step (c), which is curing the frame-gel, and then removing the plurality of nanospheres in the stacking structure by a de-sphere agent. The last step (d) includes forming a fluorescence enhancing gel-film, and the fluorescence enhancing gel-film includes the nano-scale spherical cavity structure which is distributed in a periodic or non-periodic arrangement.

### BRIEF DESCRIPTION OF THE DRAWINGS

FIG. 1 is a flowchart illustrating a method of manufacturing an embodiment of the present invention.

FIG. 2 is a schematic illustrating a stacking structure of an embodiment of the present invention.

FIG. 3 is a schematic view illustrating a frame-gel and a stacking structure of an embodiment of the present invention.

FIG. 4 is a schematic view illustrating a frame-gel and a nano-scale spherical cavity structure of an embodiment of the present invention.

FIG. 5 is a schematic view illustrating a frame-gel and a nano-scale spherical fluorescent structure of an embodiment of the present invention.

FIG. 6 is an electron-microscopic view illustrating a stacking structure of an embodiment of the present invention.

FIG. 7 is an electron-microscopic view illustrating a stacking structure of another embodiment of the present invention.

FIG. 8 is an electron-microscopic view illustrating a frame-gel and a stacking structure of an embodiment of the present invention.

FIG. 9 is an electron-microscopic view illustrating a frame-gel and a periodic nano-scale spherical cavity structure of an embodiment of the present invention.

FIG. 10 is an electron-microscopic view illustrating a frame-gel and a non-periodic nano-scale spherical cavity structure of another embodiment of the present invention.

FIG. 11 is an electron-microscopic view illustrating a frame-gel and a periodic nano-scale spherical fluorescent structure of an embodiment of the present invention.

FIG. 12 is an electron-microscopic view illustrating a frame-gel and a non-periodic nano-scale spherical fluorescent structure of another embodiment of the present invention.

FIG. 13 is a line chart illustrating a light intensity of each wavelength and reflectance of structure in an embodiment of the present invention.

FIG. 14 is a line chart illustrating a light intensity of each wavelength and reflectance of structure in another embodiment of the present invention.

FIG. 15 is a comparison chart illustrating a light intensity of each wavelength of an embodiment of the present invention and a general fluorescent film.

### DESCRIPTION OF THE PREFERRED EMBODIMENTS

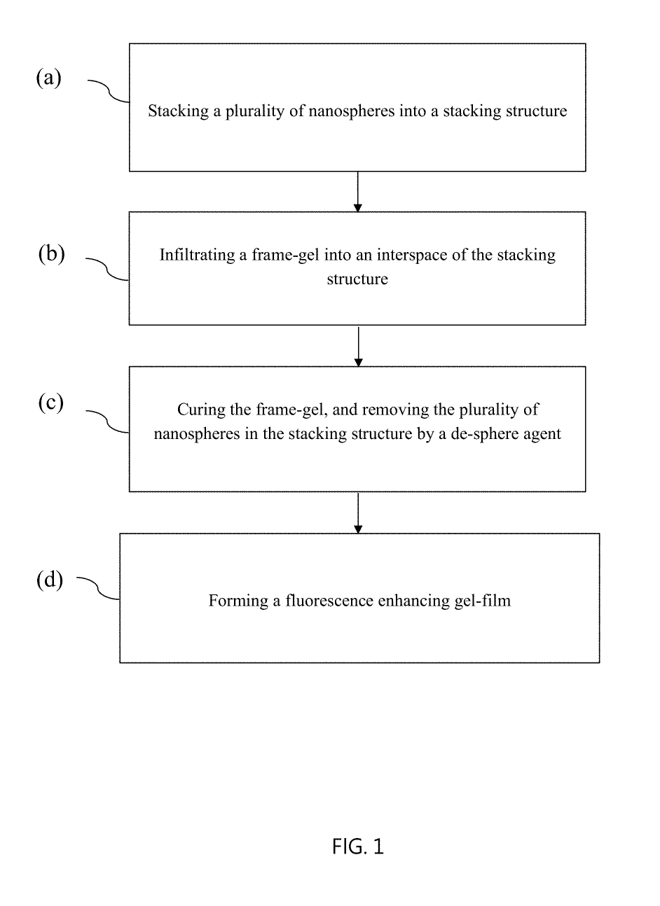

Please refer to FIG. 1, which shows a flowchart illustrating a method of manufacturing an embodiment of the present invention. FIG. 1 illustrates the method of manufacturing a fluorescence enhancing gel-film according to the embodiment of the present invention. First of all, a plurality of nanospheres are stacked into a periodic or non-periodic stacking structure in step (a). In the following step (b), a frame-gel is infiltrated into an interspace of the stacking structure. In the next step (c), curing the frame-gel and removing the plurality of nanospheres in the stacking structure by a de-sphere agent. The last step (d), a fluorescence enhancing gel-film which includes a periodic or non-periodic nano-scale spherical cavity structure has been formed.

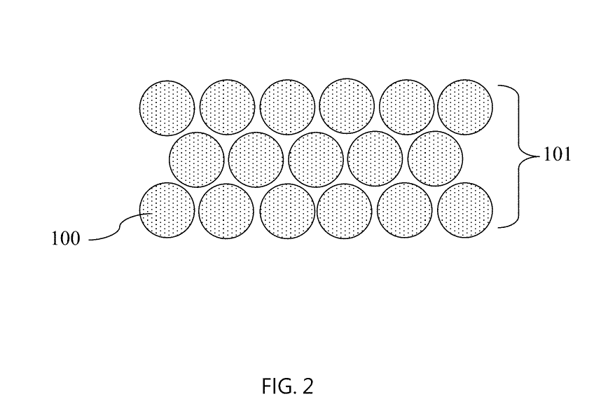

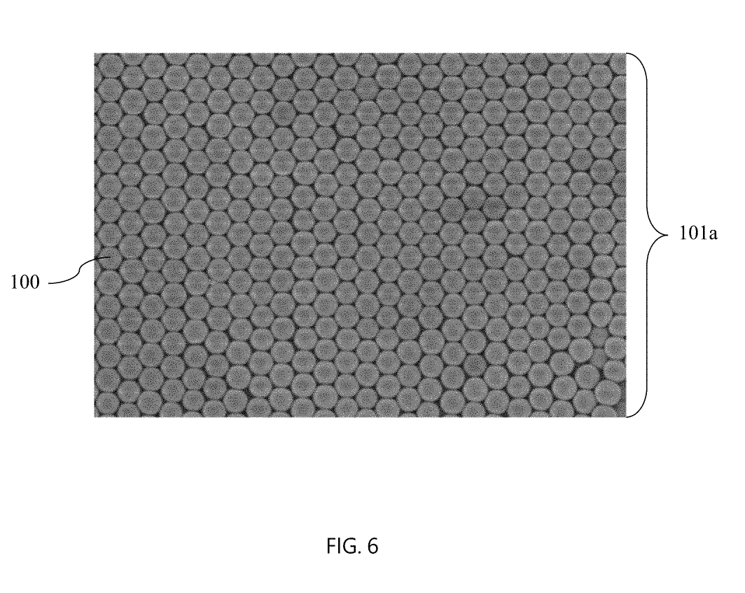

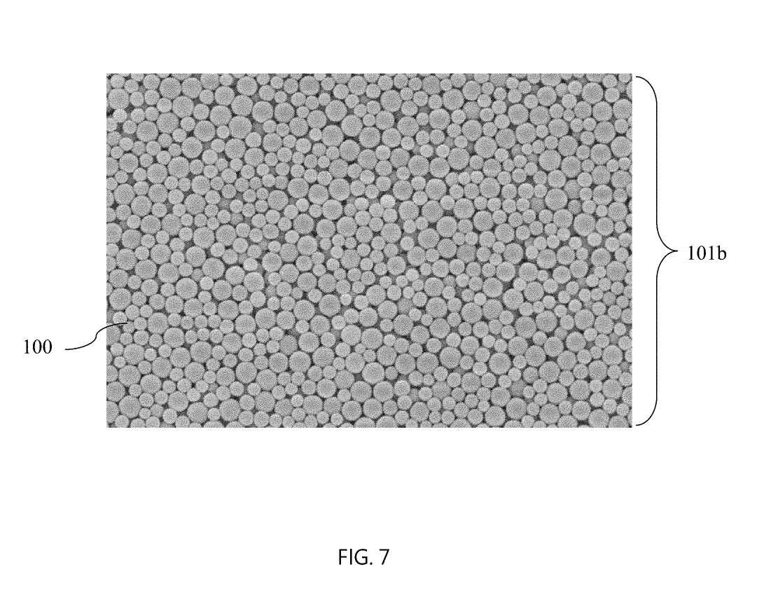

In step (a) of the manufacturing method, a plurality of nanospheres are stacked into a periodic or non-periodic stacking structure. Please refer to FIG. 2, FIG. 6 and FIG. 7 simultaneously. FIG. 2 shows a schematic illustrating a stacking structure of an embodiment of the present invention; FIG. 6 shows an electron-microscopic view illustrating a stacking structure of an embodiment of the present invention; and FIG. 7 shows an electron-microscopic view illustrating a stacking structure of another embodiment of the present invention. In step (a), a plurality of nanospheres 100 are stacked into a periodic or non-periodic stacking structure 101 with reference to FIG. 2. FIG. 6 shows a plurality of nanospheres 100 are stacked into a periodic stacking structure 101a, and FIG. 7 shows a plurality of nanospheres 100 are stacked into a non-periodic stacking structure 101b.

In this embodiment, a plurality of nanospheres 100 can be selected from a group consisting of silicon compound and a high-molecular polymer.

Furthermore, a plurality of nanospheres 100 can be selected from a group consisting of SiO₂, polystyrene, polydimethylsiloxane or polymethylmethacrylate. The diameter of each nanospheres 100 is between 10 (nm) and 1000 (nm).

In this embodiment, the method in which the nanospheres 100 are stacked into a periodic or non-periodic stacking structure 101 are generated by an ink-jet, a spray, a nozzle, a scraper, a blade a spin, or a slit.

In the case where the stacking structure 101 has a periodicity in the form of stacking, the crystal structure of the stacking structure 101 may be a body-centered cubic crystal structure, a face-centered cubic crystal structure or a simple cubic crystal structure. In addition, the arrangement of the plurality of nanospheres 100 may be a non-close-packed crystal structure or a close-packed crystal structure.

Each body-centered cubic unit includes two nanospheres 100. Two nanospheres of each body-centered cubic unit comprises eight corner nanospheres, each corner nanosphere is equal to one-eighth of single nanosphere 100, and a single nanospheres 100 in the center. The nanospheres 100 in the body-centered cubic crystal structure have a bulk density of 68%. Each face-centered cubic unit includes four nanospheres 100. Four nanospheres 100 of each face-centered cubic unit include eight corner nanospheres and six face-centered nanospheres which is equal to one half of single nanosphere 100. The nanospheres 100 in the face-centered cubic crystal structure have a bulk density of 74%. Each simple cubic unit includes eight corner nanospheres, and the nanospheres 100 in the simple cubic crystal structure have a bulk density of 52%.

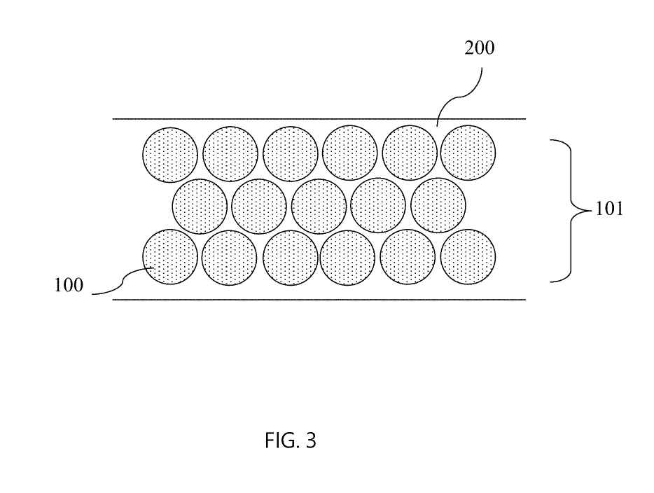

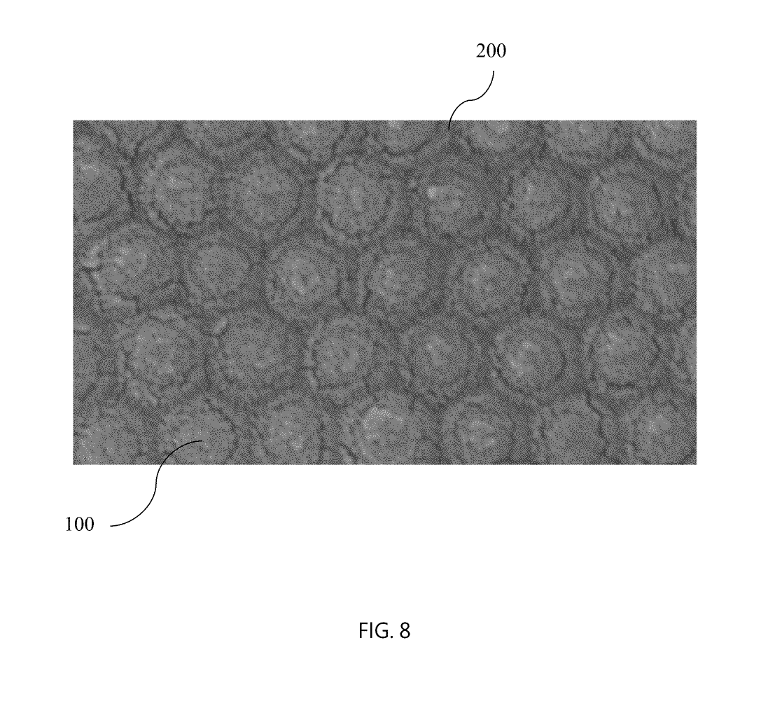

In the next step (b), a frame-gel is infiltrated into an interspace of the stacking structure. Please refer to FIG. 3 in conjunction with FIG. 8. FIG. 3 shows a schematic view illustrating a frame-gel and a stacking structure of an embodiment of the present invention, FIG. 8 shows an electron-microscopic view illustrating a frame-gel and a stacking structure of an embodiment of the present invention. The step (b) is based on the stacking structure 101, which infiltrates the liquid frame-gel 200 into the interspaces of the stacking structure 101, whether the stacking structure 101 is periodic or non-periodic. In this embodiment, the liquid frame-gel 200 may be selected from a light-curable adhesive or a thermal-curable adhesive mixed with a fluorescent material, or selected from a pure light-curable adhesive or a pure thermal-curable adhesive.

The light-curable adhesive in this embodiment may be a UV-curable adhesive. Furthermore, the material of the light-curable adhesive includes an acrylate monomer, an acrylate oligomer monomer, or a combination thereof. In this embodiment, the material of the light-curable adhesive is implemented with the acrylate monomer. Mainly due to the excellent weather ability, transparency, color retention and mechanical strength of acrylates, while acrylate monomers can be selected from tripropylene glycol diacrylate (TPGDA), neopropyl glycol diacrylate (NPGDA), propoxylated neopropyl glycol diacrylate (PO-NPGDA), trimethylolpropane triacrylate (TMPTA), propoxylated glyceryl triacrylate (GPTA), ethoxylated trimethylolpropane triacrylate (EO-TMPTA), propoxylated trimethylolpropane triacrylate (PO-TMPTA), di-trimethylolpropane tetraacrylate (di-TMPTA), ethoxylated pentaerythritol tetraacrylate (EO-PETA), dipentaerythritol hexaacrylate (DPHA), or a combination thereof.

Certainly, the light-curable adhesive in this embodiment may also be selected an acrylate oligomeric monomer as a light-curable adhesive material, such as epoxy acrylate (EA), urethane acrylate (PUA), polyester acrylate (PEA), unsaturated polyester acrylate (UPE), amine acrylate, silicon acrylate, or a combination thereof.

On the other hand, a thermal-curable tannin resin may be used while the frame-gel is a thermal-curable adhesive. The thermal-curable adhesive cures the frame-gel 200 by heating in an oven or adding a hardener, which is selected from methyl silicon, phenyl silicon, or a combination thereof. In this embodiment, the thickness of frame-gel 200, generated by the completion of infiltration, is between 0.001 mm and 1.0 mm.

In other implementable embodiments, the frame-gel 200 is further mixed with a fluorescent material which is selected from a group consisting of quantum dot, a phosphor powder, a dye and a combination thereof. Specifically, the quantum dot, the phosphor, or the dye is mixed in the frame-gel 200 which is still in a liquid state. According to the different material of the frame-gel 200, different solvents, such as toluene or ethanol, can be mixed in the frame-gel 200 to assist the blending.

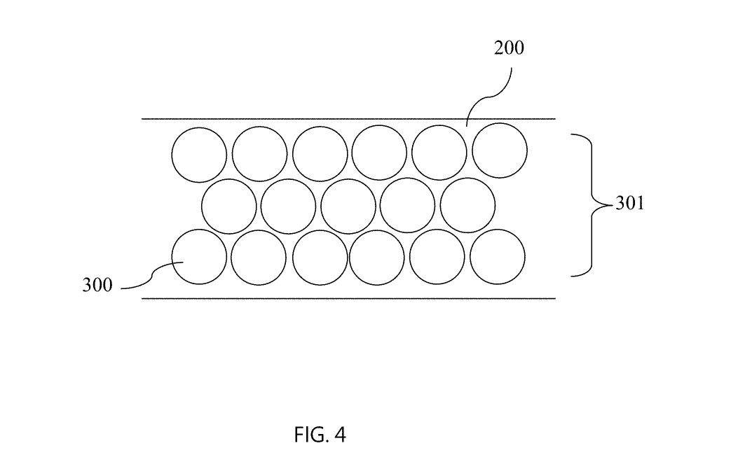

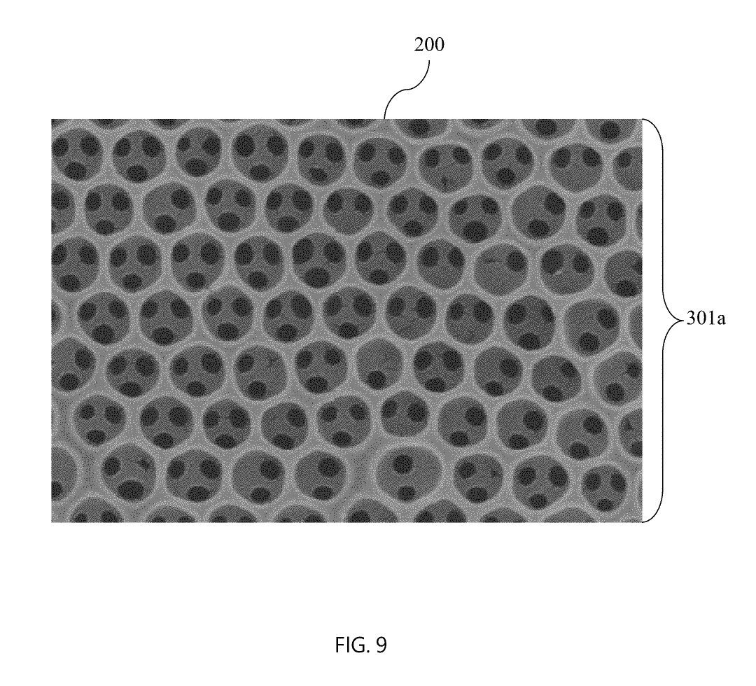

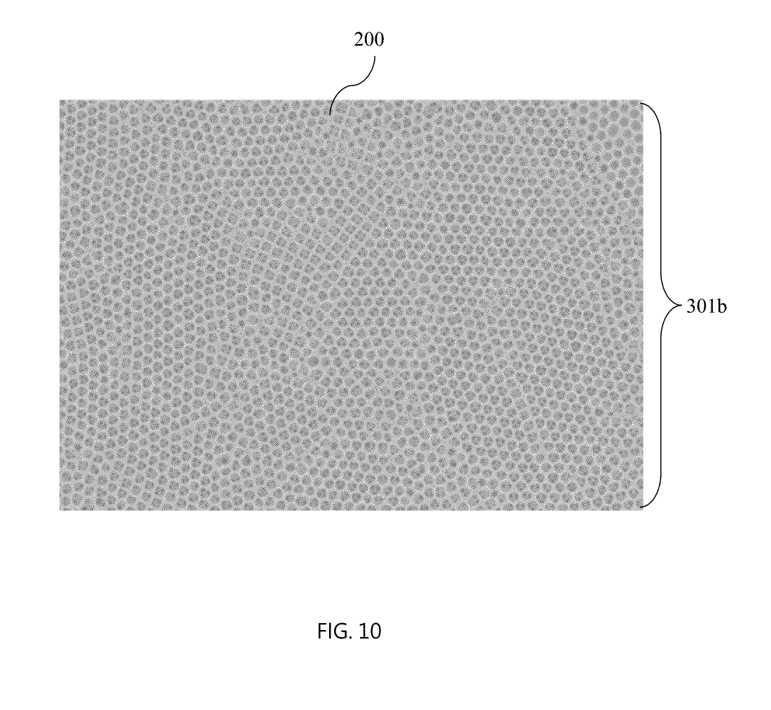

After the completion of step (b), the frame-gel is cured, and then the plurality of nanospheres of the stacking structure is removed by a de-sphere agent. To begin with, the method of curing the frame-gel 200 is different through the type of the frame-gel 200. For example, when the frame-gel 200 is a light-curable adhesive containing a light hardener, the frame-gel 200 would be cured by an external environmental factor such as ultraviolet rays. On the contrary, when the frame-gel 200 is a thermal-curable adhesive, it would be cured by heating in the oven. After curing the frame-gel 200, please refer to FIG. 4, FIG. 9 and FIG. 10.

As show in FIG. 4, after the frame-gel 200 has been cured, a de-sphere agent removes plurality of nanospheres 100 of the stacking structure 101. The remaining frame-gel 200, after removing plurality of nanospheres 100 of the stacking structure, will be as shown in FIG. 4, FIG. 9 and FIG. 10. In this embodiment, when the material of the plurality of nanospheres 100 is selected by the germanium compound, the de-sphere agent would be hydrofluoric acid (HF). The aforesaid hydrofluoric acid (HF) can remove the plurality of nano-spheres 100 in the stacking structure 101 without corroding the frame-gel 200. On the other hand, when the plurality of nanospheres 100 is high molecular polymers, the de-sphere agent would use the organic solvent to achieve the purpose.

In this embodiment, the organic solvent as the de-sphere agent can be selected from ethanol, dichloromethane, benzene, tetrachloromethane or chloroform. Chloroform is the preferred de-sphere agent in this embodiment. However, considering the condition of the different material of the light-curable adhesive or the thermal-curing adhesive of the frame-gel 200, the option of the organic solvent should be selected to those which only remove the plurality of nanospheres 100 without corroding the frame-gel 200.

After removing the plurality of nanospheres 100, a plurality of nano-scale spherical cavities 300 are formed correspondingly. As described in the step (d), a fluorescence enhancing gel-film which includes a periodic or a non-periodic nano-scale spherical cavity structure 301 can be formed. Please refer to FIG. 4, FIG. 9 and FIG. 10 simultaneously, when the plurality of nanospheres 100 are arranged in the periodic stacking structure 101a (as shown in FIG. 6), the spherical cavity structure 301 would become a periodic nano-scale spherical cavity structure 301a as shown in FIG. 9. On the contrary, when the plurality of nanospheres 100 are arranged in the non-periodic stacking structure 101b (as shown in FIG. 7), the nano-scale spherical cavity structure 301 would become a non-periodic nano-scale spherical cavity structure 301b as shown in FIG. 10.

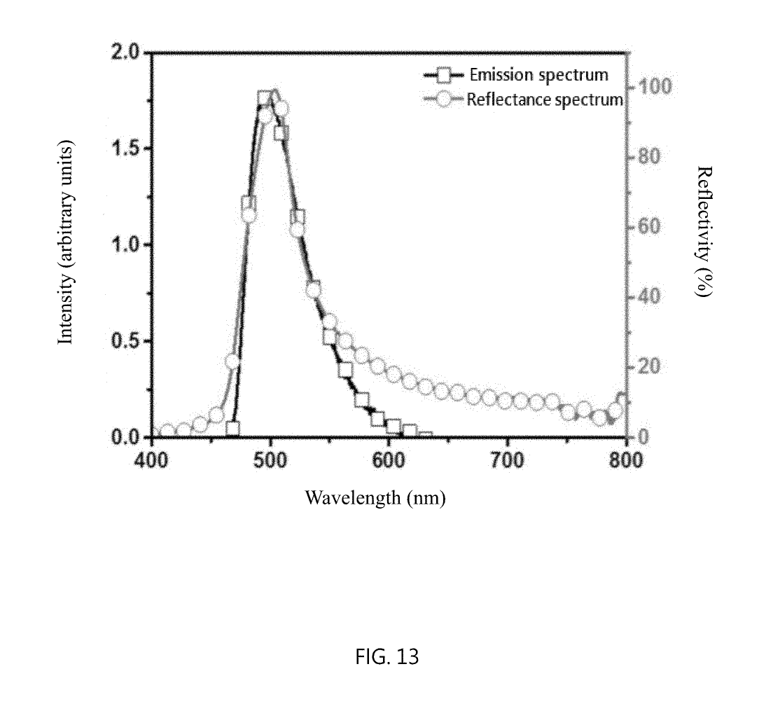

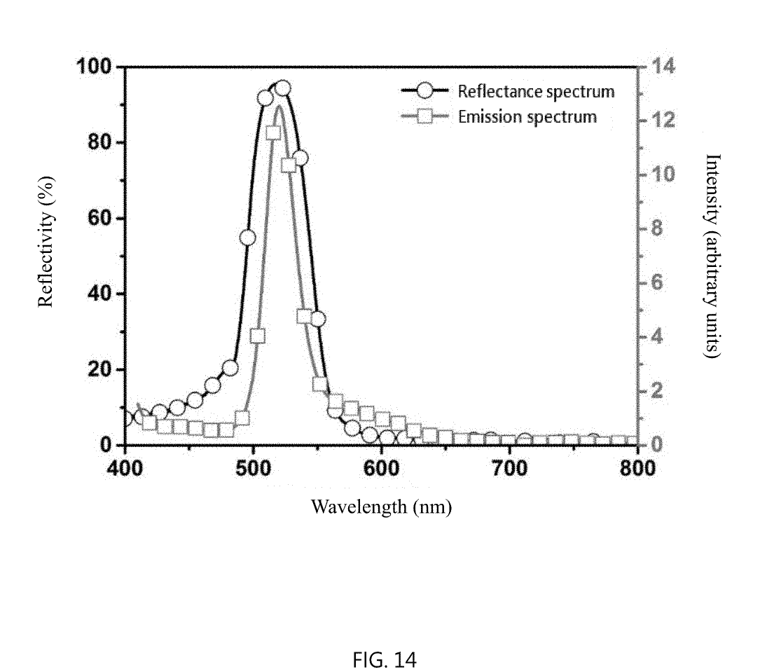

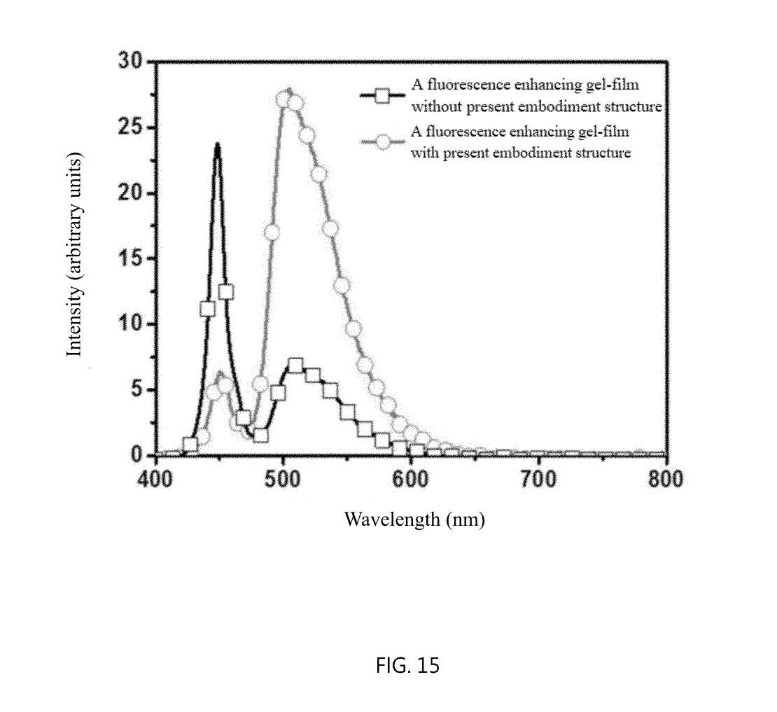

According to the FIG. 9 and FIG. 10, actually, the fluorescence enhancing gel-film is manufactured by the step (d), whether the periodic nano-scale spherical cavity structure 301a or the non-periodic stacking structure 101b, each nano-scale spherical cavities 300 includes small hole that can communicate with each other in the nano-scale spherical cavity structure 301. Therefore, please refer to the optical characteristics of FIGS. 13 to 15 simultaneously. FIG. 13 shows a line chart illustrating a light intensity of each wavelength and reflectance of structure in an embodiment of the present invention. FIG. 14 shows a line chart illustrating a light intensity of each wavelength and reflectance of structure in another embodiment of the present invention. FIG. 15 shows a comparison chart illustrating a light intensity of each wavelength of an embodiment of the present invention and a general fluorescent film.

FIG. 13 shows a line chart illustrating a light intensity and a reflectivity of each wavelength of the periodic nano-scale spherical cavity structure 301a in the present fluorescence enhancing gel-film. Both the reflectivity and luminescence spectrum of periodic nano-scale spherical cavity structure 301 show a narrow FWHM. However, the reflectivity and luminescence spectrum of the non-periodic nano-scale spherical cavity structure 301b in FIG. 14 has shown a wider FWHM and it results in that the luminescence spectrum of the FWHM becomes narrower. Finally, in comparison with a general fluorescence enhancing gel-film without periodic nano-scale spherical cavity structure 301a or non-periodic nano-scale spherical cavity structure 301b, FIG. 15 shows a comparison chart illustrating a light intensity of each wavelength of the embodiment of the present invention and the general fluorescent film.

As show in FIG. 15, the fluorescence enhancing gel-film manufactured by the embodiment of the present invention may effectively increase the light intensity of a specific wavelength spectrum (such as the color light of 500 to 600 nm wavelength in FIG. 15) up to four times the effectiveness of the general gel-film. Since the fluorescence enhancing gel-film manufactured in this embodiment has a photonic band to enhance the quantum efficiency of the fluorescent material, it is obvious that the fluorescence enhancing gel-film manufactured by the embodiment of the present invention has considerable unobviousness.

Furthermore, the fluorescence enhancing gel-film manufactured in the present embodiment has a photonic band to modulate the spontaneous emission of a luminescent substance. According to Fermi's golden rule, the probability of spontaneous emission is proportional to the local photon density of states. When the density of states of electromagnetic waves is 0, the probability of spontaneous emission is 0 as well, that is, there is no spontaneous emission. The density of states of the center of the photonic band is small, for example, the periodic nano-scale spherical cavity structure 301a in the embodiment of the present disclosure is taken as the explanation basis. When the frequency falls within periodic nano-scale spherical cavity structure 301a in the embodiment of the present invention, spontaneous emission of electromagnetic waves in the photon band would be suppressed. Conversely, the density of states of the edge of the photonic band is the largest, thus, the light spectrum of the material which can be modulated becomes narrower, and the color purity becomes higher.

Thus, when the fluorescence wavelength of the fluorescent material mixed in the frame-gel 200 falls in the center of the photonic band, its spontaneous emission will be suppressed, and the spontaneous emission in the edge of the photon band will be enhanced. Therefore, as an example, when the fluorescent material of the present invention is mixed in the frame-gel 200 and includes a periodic nano-scale spherical cavity structure 301a, redistribution of the photonic modes near the photonic band would change the spontaneous emission of the fluorescent material of the periodic structure 301a, and change the luminescence spectrum of fluorescent material significantly.

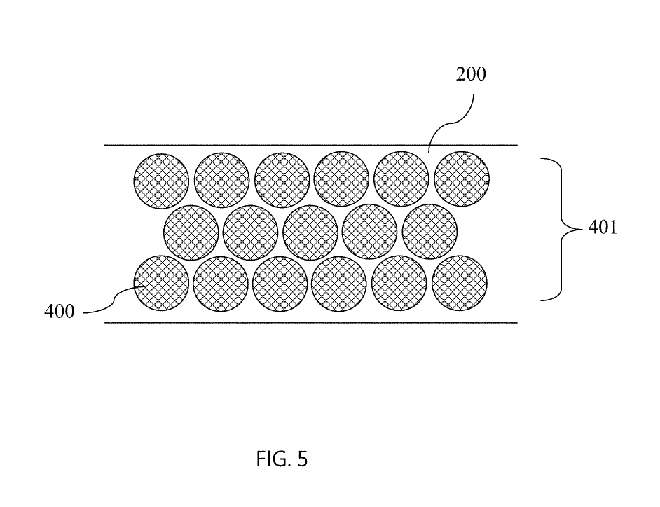

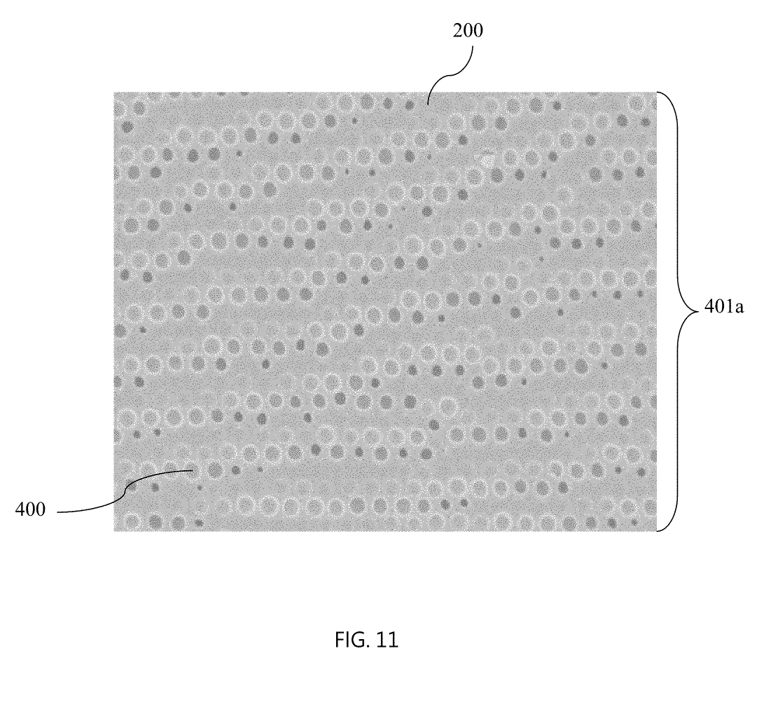

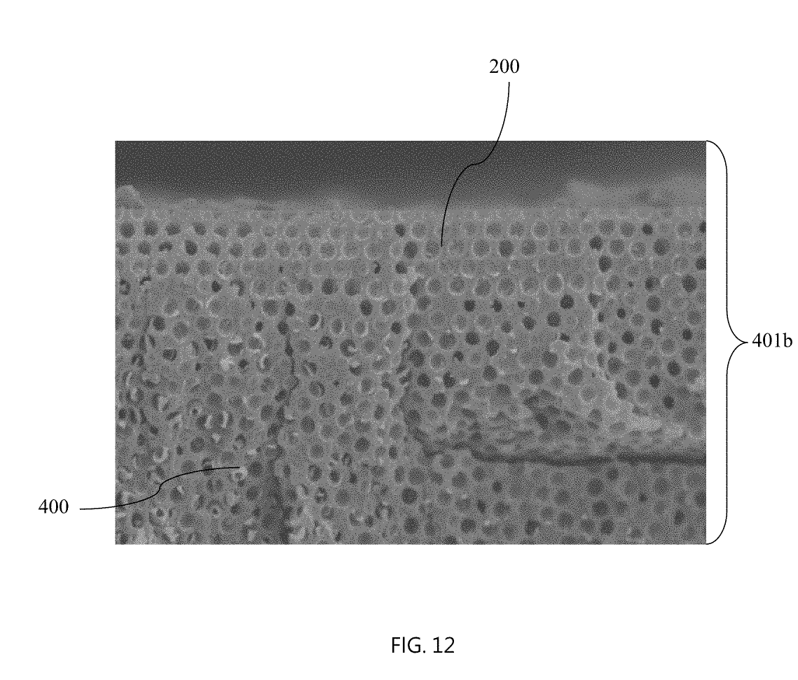

According to the aforementioned words, when the embodiment of the present invention selects the frame-gel 200 mixed with the fluorescent material, its fluorescence characteristics can be regulated by the photonic band of the fluorescent material, this characteristic is based on the structure of refractive index change of periodic structure. In addition, the fluorescent material 400 including fluorescent material (refer to FIG. 5, FIG. 11 and FIG. 12 at the same time) is infiltrated into the periodic nano-scale spherical cavity structure 301a, and the structure 301a can not only break the co-action of the fluorescent material through the porous structure, but also effectively suppress the fluorescence quenching of the fluorescent material and increase the quantum yield. Furthermore, the fluorescence spectrum of the fluorescent material can be regulated through the photonic band. Certainly, even when the present invention is implemented as a non-periodic nano-scale spherical cavity structure 301b, the same characteristics are provided as well.

Therefore, based on the concept as mentioned above, other possible embodiments can be provided. In other possible embodiments of the present invention, after the implementation of step (d), there is a need to increase the light intensity of a spectrum with wavelengths, a step (e) can be further performed. In the step (e), a fluorescent adhesive is infiltrated into the nano-scale spherical cavity structure of the fluorescence enhancing gel-film, and correspondingly forming a periodic or a non-periodic nano-scale spherical fluorescent structure.

Please refer to FIG. 5, FIG. 11 and FIG. 12 at the same time. FIG. 5 shows a schematic view illustrating a frame-gel and a nano-scale spherical fluorescent structure of an embodiment of the present invention. FIG. 11 shows an electron-microscopic view illustrating a frame-gel and a periodic nano-scale spherical fluorescent structure of an embodiment of the present invention. FIG. 12 shows an electron-microscopic view illustrating a frame-gel and a non-periodic nano-scale spherical fluorescent structure of another embodiment of the present invention.

As shown in FIG. 5, in view of the aforementioned periodic nano-scale spherical cavity structure 301a or non-periodic nano-scale spherical cavity structure 301b, each nano-scale spherical cavity 300 is connected through at least one small hole. On the other words, when each nano-scale spherical cavity 300 is filled with liquid, there will be a capillary action to make the liquid spread throughout the periodic nano-scale spherical cavity structure 301a or the non-periodic nano-scale spherical cavity structure 301b. Therefore, the liquid fluorescent adhesive 400 in the step (e) is infiltrated into the periodic nano-scale spherical cavity structure 301a or the non-periodic nano-scale spherical cavity structure 301b to form a periodic or non-periodic nano-scale spherical fluorescent structure 401.

Therefore, according to the step (d) and (e), when the fluorescence enhancing gel-film of step (d) is a periodic nano-scale spherical cavity structure 301a, the liquid fluorescent adhesive 400 is penetrated into a nano-scale spherical fluorescent structure 401, and the nano-scale spherical fluorescent structure 401 becomes a periodic nano-scale spherical fluorescent structure 401a as shown in FIG. 11. On the contrary, when the fluorescence enhancing gel-film of step (d) is a non-periodic nano-scale spherical cavity structure 301b, the liquid fluorescent adhesive 400 is penetrated into a nano-scale spherical fluorescent structure 401, and then the nano-scale spherical fluorescent structure 401 becomes a non-periodic nano-scale spherical fluorescent structure 401b as shown in FIG. 12.

The material of the fluorescent adhesive 400 in the present embodiment may be the same or different from the material of the aforementioned frame-gel 200. A user may mix quantum dots, phosphor powder, dyes, or the combination thereof as required in the liquid state of the fluorescent adhesive 400, so as to achieve the optical characteristics of the fluorescence enhancing gel-film what the user desires in this embodiment.

Therefore, through the fluorescence enhancing gel-film manufactured by the present embodiment usually includes the frame-gel 200 and the nano-scale spherical cavity structure 301. The frame-gel 200 is in the form of a thin film, and nano-scale spherical cavity structure 301 is disposed in the frame-gel 200. The nano-scale spherical cavity structure 301 is distributed in a periodic or a non-periodic arrangement.

In some embodiments of the fluorescence enhancing gel-film, the frame-gel 200 is further mixed with a fluorescent material. The fluorescent material may be selected from a quantum dot, a phosphor powder, a dye or a combination thereof. In others embodiments of the fluorescence enhancing gel-film, spherical cavity structure 301 further includes a nano-scale spherical fluorescent structure 401.

What is claimed is:

1. A method of manufacturing a fluorescence enhancing gel-film, comprising the steps of:
(a) stacking a plurality of nanospheres into a stacking structure; wherein the stacking structure is periodic or non-periodic;
(b) infiltrating a frame-gel into an interspace of the stacking structure;
(c) curing the frame-gel, and removing the plurality of nanospheres in the stacking structure by a de-sphere agent; and
(d) forming a fluorescence enhancing gel-film, wherein the fluorescence enhancing gel-film includes a nano-scale spherical cavity structure;
wherein the nano-scale spherical cavity structure is periodic or non-periodic.

2. The method according to claim 1, wherein the plurality of nanospheres in step (a) is made of a silicon compound or a high-molecular polymer.

3. The method according to claim 2, wherein the plurality of nanospheres in step (a) is made of the silicon compound, and a hydrofluoric acid (HF) is used as the de-sphere agent in step (c).

4. The method according to claim 2, wherein the plurality of nanospheres in step (a) is the high-molecular polymer, and an organic solvent is used as the de-sphere agent in step (c).

5. The method according to claim 4, wherein the organic solvent is ethanol, dichloromethane, benzene, tetrachloromethane or chloroform.

6. The method according to claim 1, wherein the frame-gel in the step (b) is a light-curable adhesive or a thermal-curable adhesive.

7. The method according to claim 1, wherein the frame-gel in the step (b) further mixes with a fluorescent material, wherein the fluorescent material comprises a quantum dot, a phosphor powder, a dye or a combination thereof.

8. The method according to claim 1, wherein a step (e) is performed after the step (d), comprising:
infiltrating a fluorescence gel into the nano-scale spherical cavity structure of the fluorescence enhancing gel-film, and forming a nano-scale spherical fluorescent structure; wherein the nano-scale spherical fluorescent structure is periodic or non-periodic.

9. The method according to claim 8, wherein the fluorescent gel in the step (e) further mixes with a quantum dot, a phosphor powder, a dye or a combination thereof.

10. A fluorescence enhancing gel-film comprising:
a frame-gel in a form of a film; and
a nano-scale spherical cavity structure disposed in the frame-gel, wherein the nano-scale spherical cavity structure is distributed in an arrangement;
wherein the arrangement is periodic or non-periodic.

11. The fluorescence enhancing gel-film according to claim 10, wherein the frame-gel further mixes with a fluorescent material; wherein the fluorescent material comprises a quantum dot, a phosphor powder, a dye or a combination thereof.

12. The fluorescence enhancing gel-film according to claim 10, wherein the nano-scale spherical cavity structure further comprises a nano-scale spherical fluorescent structure.
